(19) United States
(12) Patent Application Publication
(10) Pub. No.: US 2026/0024104 A1
(43) Pub. Date: Jan. 22, 2026

(54) PREDICTING USER ENGAGEMENT USING EMOTION-BASED GESTURE ANALYSIS

(71) Applicant: Emaww, Longueuil (CA)

(72) Inventors: Alicia Heraz, Longueuil (CA); Kiran Kumar Ashish Bhyravabhottla, Longueuil (CA); Nandith Sajith, Longueuil (CA)

(21) Appl. No.: 19/274,235

(22) Filed: Jul. 18, 2025

Related U.S. Application Data
(60) Provisional application No. 63/673,515, filed on Jul. 19, 2024.

(51) Int. Cl. G06Q 30/0201; G06F 3/0488

(52) U.S. Cl. CPC G06Q 30/020112; G06F 3/0488

(57) ABSTRACT

Methods, systems, and apparatus, including computer programs encoded on computer storage media, for predicting a user's engagement. In some implementations, a system obtains data indicative of a time evolving movement of interactions of a user with a website shown on the client device. The system determines, using a first trained machine learning model and based on the data indicative of the time evolving movement of the user, a metric associated with an emotion of the user corresponding to the user's interaction with the website. The system obtains, from a metric database, one or more metrics associated with an identifier of the user. The system provides, to a second trained machine learning model, (i) the metric associated with the emotion and (ii) data representing the obtained metrics. In response, the system generates, using the second trained machine learning model, a prediction indicating an engagement level of the user.

### CROSS-REFERENCE TO RELATED APPLICATION

This application claims the benefit of U.S. Provisional Application No. 63/673,515 filed on Jul. 19, 2024, which is incorporated herein by reference.

### TECHNICAL FIELD

This specifications describes technologies related to processes to predict a user's level of engagement with websites using emotion gesture analysis.

### BACKGROUND

Individuals attempt to characterize their emotional state, and to unlock and better understand not only their expressed emotions, but the underlying causes of the expressed emotions. Further, individuals attempt to share indicia of their emotional state based on graphical representations, such as an emoji shared by an individual across a text-messaging platform or among linked members of a social network.

### SUMMARY

This specification describes techniques that predict a level or degree of a user's engagement with a website visited by the user, according to emotional experience expressed by the user upon visiting the website (also referred to interchangeably as a “site”). In some implementations, the disclosed techniques comprise a system that leverages emotion-based gesture analysis to understand users' initial impressions of a website. Using the emotion-based gesture analysis, the system can determine a user's level of engagement with the site. In some cases, based on the user's level of engagement with the site, the system can provide recommendations for tailoring website content and design elements to improve user engagement with the site, for example to elicit positive emotional responses, which can enhance overall user engagement. Accordingly, the disclosed techniques can enable a system to improve a website's layout, content presentation, and user interface design, which can lead to more effective user interactions and potentially higher conversion rates.

As a result, the system seeks to improve the overall user experience with a site by improving a user's emotional engagement in website design and optimization efforts. Accordingly, by understanding and determining the impact of users' initial impressions on their overall perception of a site, website developers can focus on creating engaging and emotionally resonant experiences to foster long-term user satisfaction and loyalty.

For instance, an expressed emotion may reflect a natural, instinctive state of mind deriving from the individual's circumstances, mood, or relationships with other individuals, and may include, but are not limited to, anger, awe, desire, fear, grief, hate, laughter, love, and scurry. Each of the expressed emotions may be correlated or associated with a detectable intensity. Based on the detected expressed emotion and the corresponding intensity, the system can better analyze the sub-conscious nature of touch gestures and gather emotional data, which allows for a more authentic and unbiased user interaction with websites.

In some implementations, determining first impression have been shown to be powerful in a wide range of contexts, including studies of websites exploring perceptions of appeal and usability. First impression can be defined as a quick evaluation made by the consumer during the first few minutes of an encounter with a product or object. Some studies indicate that web designers, for example, had about 50 milliseconds to make a good first impression on users. In some cases, some studies found that the total fixation time was greater for websites that received favorable impressions than those who were not. A web interface that is boring, a multimedia presentation that does not captivate users' attention or an online forum that fails to engender a sense of community are quickly dismissed with a simple mouse click. This highlights the importance of initial impressions to users when first visiting a website and its relation to their subsequent online experience.

In some implementations, the system can utilize an artificial intelligence machine learning (AI/ML) model that is trained to analyze the diverse content structures influencing website engagement and produce a prediction with high accuracy, enhanced understanding of user engagement, and provides new avenues for optimizing user experience with the website. Moreover, the use of the trained AI/ML model allows the system to provide actionable recommendations for enhancing user receptivity, suggesting changes in content, layout, style, and colors, to name a few examples.

In one general aspect, a method is performed by one or more computers, such as a server. The method includes: obtaining, from a client device, data indicative of a time evolving movement of interactions of a user with a website shown on the client device; determining, using a first trained machine learning model and based on the data indicative of the time evolving movement of the user interacting with the website, a metric associated with an emotion of the user corresponding to the user's interaction with the website; obtaining, from a metric database, one or more metrics associated with an identifier of the user, wherein the metrics represent data determined from prior interactions of the user with the website; providing, to a second trained machine learning model, (i) the metric associated with the emotion of the user and (ii) data representing the obtained metrics associated with the identifier of the user; in response to the providing, generating, using the second trained machine learning model, a prediction indicating an engagement level of the user with the website; and providing, to one or more devices, data representing the prediction as output.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, obtaining the data indicative of the time evolving movement of the user with the website shown on the client device further includes: determining normalized values for the data indicative of the time evolving movement; and generating feature values that characterize the normalized values, wherein the generated feature values comprise at least one of speed, acceleration, contact duration, a change in contact pressure, or a finger size.

In some implementations, wherein obtaining the data indicative of the time evolving movement of the user with the website shown on the client device further comprises: obtaining, from the client device, the data indicative of the time evolving movement of a portion of a body of the user with the website shown on the client device, wherein the portion of the body comprises a finger and the client device comprises a touchscreen display.

In some implementations, determining the metric associated with an emotion of the user corresponding to the user's interaction with the website includes: obtaining, from the first trained machine learning model, a vector that comprises a plurality of emotions and a likelihood for each emotion of the plurality of emotions, wherein a likelihood represents how likely a corresponding emotion represents the data indicative of the time evolving movement of the user; comparing the likelihood for each emotion of the plurality of emotions to a threshold value; and in response to comparing the likelihood for each emotion of the plurality of emotions to the threshold value, selecting, as the metric associated with the emotion, the emotion of the plurality of emotions whose likelihood satisfies the threshold value, wherein the metric comprises a label for the emotion and a corresponding likelihood for the emotion.

In some implementations, obtaining the one or more metrics associated with the identifier of the user further includes: determining the identifier of the user that performed a time evolving movement on the client device with the website; and selecting, from the metric database, the one or more metrics associated with the identifier of the user, wherein the one or more metrics comprise at least one of a session ID, a visitor ID, a visit count, a return, a session duration, a first impression, a number of emotions expressed, a duration of emotions expressed, entry and exit local times, or engagement information.

In some implementations, the second trained machine learning model includes a Light Gradient Boosting Machine.

In some implementations, providing, to a second trained machine learning model, (i) the metric associated with the emotion of the user and (ii) data representing the obtained metrics associated with the identifier of the user includes: generating a classification of the emotion of the user according to a table of classification values, wherein the table of classification values comprises a number for each emotion, the number representing an expression of the user for performing the time evolving movement; and providing, to the second trained machine learning model, (i) the number corresponding to the emotion and (ii) the data representing the obtained metrics associated with the identifier of the user.

In some implementations, generating, using the second trained machine learning model, the prediction indicating an engagement level of the user with the website includes generating, using the second trained machine learning model, a score that classifies the engagement level of the user with the website during a particular session.

In some implementations, the data indicative of the time evolving movement includes a plurality of contacts established sequentially between a finger of the user and a surface of a touchscreen display of the client device at corresponding contact times, wherein the plurality of contacts comprises contact positions, contact pressures, and the contact times associated with each of the contacts.

In some implementations, obtaining, from a client device, data indicative of a time evolving movement of a user interacting with a website shown on the client device includes obtaining, from the client device, data indicating the time evolving movement of the user that comprises clicks, scrolls, swipes, and taps using an input mechanism of an electronic device used to visit the website.

In some implementations, generating, using the second trained machine learning model, a prediction indicating an engagement level of the user with the website includes generating, using the second trained machine learning model, at least one of an initial emotional response of the user to the website or an overall impression of the website.

The subject matter described in this specification can be implemented in various embodiments and may result in one or more of the following advantages. In some implementations, the system provides technical advancements that include predicting a user's engagement with a website using gesture detection. For example, the system can predict emotional features from the gesture detection using one or more trained machine learning models. The predicted emotional features can be further processed by one or more additional trained machine learning models to predict the user's engagement with the website. This improves prediction accuracy for determining a user's engagement with a website through a user's behavioral analysis over a period of time.

In some cases, the system can recommend adjustments to a website to improve the user's engagement with that website. The system can analyze data associated with other websites that were detected to have a high user engagement according to detected gestures. This data can include, for example, website layouts, website color schemes, information presentation on the website, and notification location/types, to name some examples. If the system detects a website where a particular gesture resulted in a low engagement, the system can determine whether that website with the low engagement includes one or more of the features from the other websites. If the system determines the website with the low engagement lacks one or more of these features from the other websites, the system can recommend adjustments to a designer of the website in order to improve the user engagement.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram that illustrates an example of a system for predicting a user's engagement with a website according to gesture based emotion recognition.

FIG. 1B is a block diagram that illustrates an example of processes for predicting a user's engagement with a website.

FIG. 2 is a block diagram that illustrates an example integrated data flow for predicting user engagement.

FIGS. 3A-3D are example graphical user interfaces that illustrate a user's engagement with a website over time.

FIG. 4 is a flow diagram that illustrates a process for predicting a user's engagement with a website according to gesture based emotion recognition.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

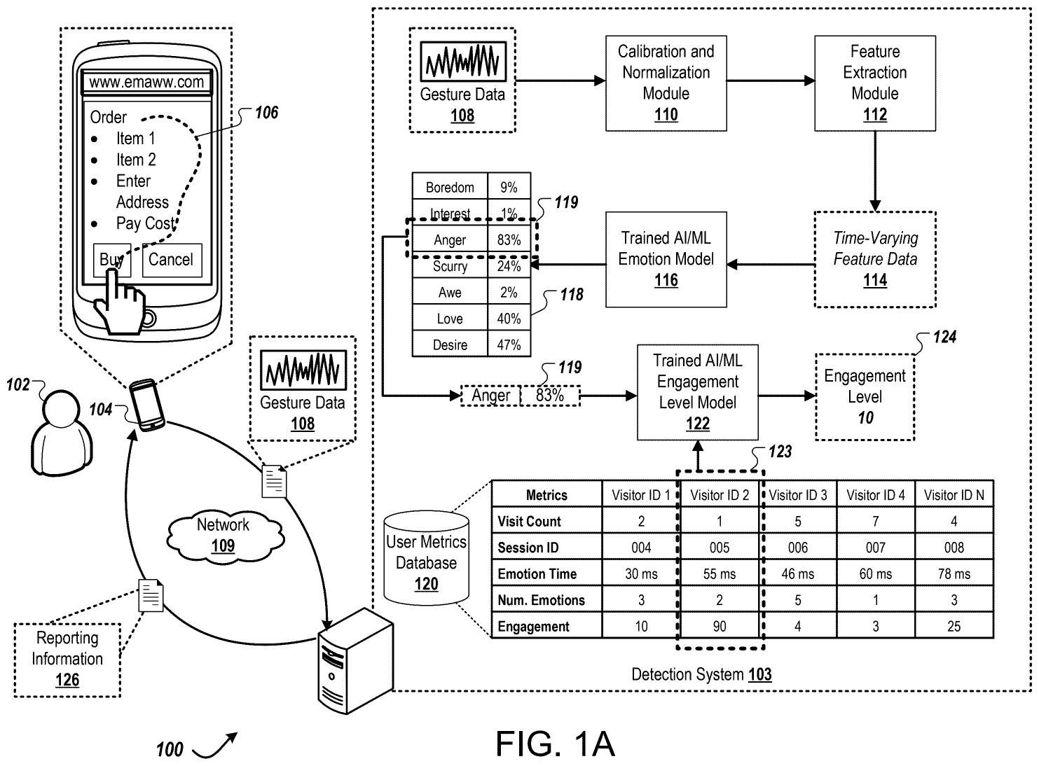

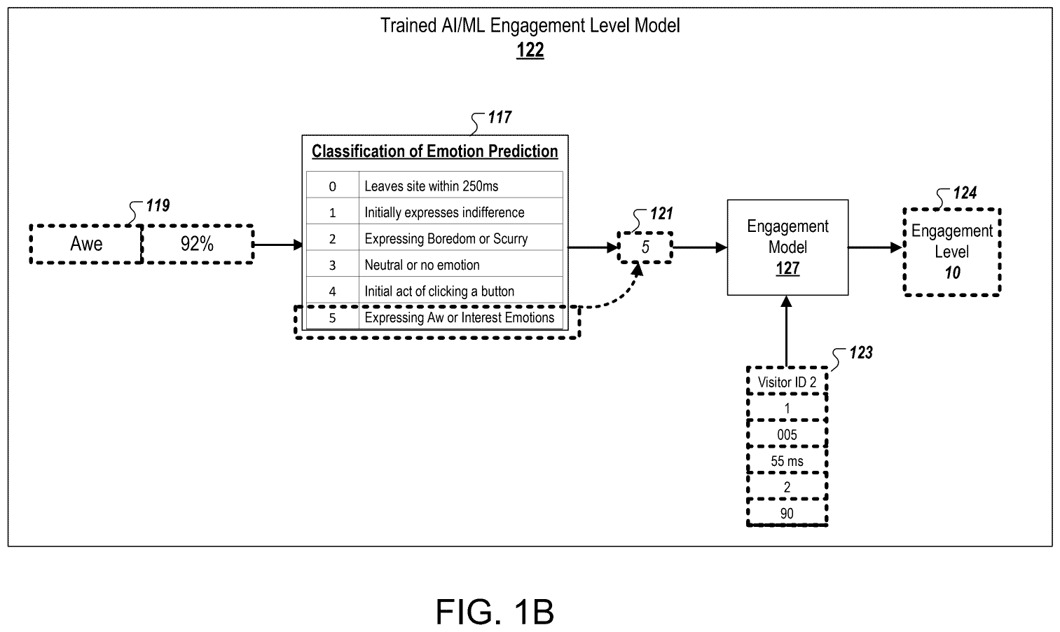

FIG. 1A is a block diagram that illustrates an example of a system 100 for predicting a user's engagement with a website according to gesture based emotion recognition. The system 100 includes a detection system 103 and a user metrics database 120. The detection system 103 can communicate with one or more client devices, such as client device 104, over a network 109. The network 109 can include a wired network, a wireless network, a local network, or an external network, such as the Internet.

Briefly, the detection system 103 can generate a prediction that indicates user 102's engagement with a website displayed on the client device 104. The system can analyze a gesture performed by user 102 on the client device 104 to predict the user's engagement with the website. For example, specific details related to the gesture detection and analysis can be found in U.S. patent application Ser. No. 15/669,316, the entire contents of which are incorporated herein by reference.

In some implementations, the detection system 103 seeks to predict a user's engagement with website displayed on client device 104 using a user's gesture on the client device 104. By predicting the engagement based on the user's gesture, the detection system 103 can discover or reveal the intention of the user, for example, what the user's gesture reveals about the user's interest or intention with the website. This allows for the detection system 103 to better understand a user's engagement with the website and allows for improving the user's overall experience with the website or with future websites.

The detection system 103 can include one or more servers or computers connected locally or over a network. The system 100 can include a network 109 that can be, for example, local network, a Wi-Fi network, an intranet, an Internet connection, a Bluetooth connection, or some other connection that enables the detection system 103 to communicate, e.g., transmit and receive, with various databases and various computers or client devices.

In some implementations, the detection system 103 can include a user metrics database 120. In some implementations, the user metrics database 120 may be stored locally or connected to the detection system 103 over network 109. The user metrics database 120 can include information associated with the user and the website the user visits. This information is calculated by the detection system 103 and aggregated over a period of time. For example, the user metrics database 120 can include information shown in Table 1 below, for each user's visit to a website. The detection system 103 can acquire data associated with a user's interaction of a website through a respective client device, extract features from the interaction, and store the extracted features in the user metrics database 120.

In some implementations, the processes performed by system 100 includes predicting users' level of engagement based on their first impressions of websites. The processes can be structured into distinct phases. The first phase is data collection, the second phase is correlation analysis. The third phase includes testing a predictive model to forecast user engagement based on their initial impressions. Other phases are also possible. For example, another phase may include deploying the trained predictive model.

In the first phase, the detection system 103 gathers real-time emotion data from a live e-commerce website, focusing on systematically structuring raw emotion data into proprietary metrics. In some cases, the detection system 103 utilizes a Gradient Boosting Classifier for the trained AI/ML emotion model 116 to discern the four emotions outlined in Table 2. In some implementations, the trained AI/ML emotion model 116 leverages gesture properties shown in Table 1 below. These gesture properties include, for example, Gesture Duration, Pause Length, Touch Count, Gesture Spread, Gesture Direction, Gesture Travel, Gesture Area, Gesture Speed, Gesture Acceleration, from which the model attributes were extracted. Through parameter tuning and algorithmic adjustments, the trained AI/ML emotion model 116 can achieve a high accuracy, e.g., over 90%, which can be in some cases 91.0% and a precision rate of 92.1%, solidifying its reliability even as it continues to evolve with ongoing data accumulation.

TABLE 1
List of Gesture Properties For Emotion Prediction

| # | Property | Description |
|---|---|---|
| 1 | Gesture | The time elapsed between the beginning and end of |
| | Duration | the gesture, measured in milliseconds (ms). |
| 2 | Pause | The duration of periods where there is no new |
| | Length | touch event input during the gesture, measured in |
| | | milliseconds (ms). |
| 3 | Touch | The number of distinct touch points registered |
| | Count | during the gesture (unitless). |
| 4 | Gesture | The difference between the maximum and minimum |
| | Spread | X and Y coordinates of touch points during the |
| | | gesture, measured in pixels (px) for both X |
| | | and Y axes. |
| 5 | Gesture | The angle between the initial and final touch |
| | Direction | points relative to a reference axis, measured |
| | | in degrees (°). |
| 6 | Gesture | The total distance covered by the touch points |
| | Travel | during the gesture, considering each movement |
| | | between subsequent touch points, measured in |
| | | pixels (px). |
| 7 | Gesture | The area covered by the touch points during the |
| | Area | gesture, measured in square pixels (px²). |
| 8 | Gesture | The average speed of the gesture, calculated by |
| | Speed | dividing the total distance traveled by the gesture |
| | | duration, measured in pixels per second (px/s). |
| 9 | Gesture | The rate of change of gesture speed over time, |
| | Acceleration | estimated by analyzing the change in velocity between |
| | | subsequent time intervals, measured in pixels per |
| | | second squared (px/s²). |

In some examples, four emotions and their corresponding description determined by the detection system 103 are shown in Table 2.

TABLE 2
List of Emotions Collected by the Emaww API

| Emotion | Description |
|---|---|
| Awe | Awe is a wondrous expression where users become deeply |
| | moved and connected to the content. They're almost |
| | frozen as they absorb new material that resonates with |
| | their interests and captivates their minds. |
| Interest | When users are interested, they exhibit attentiveness and |
| | curiosity towards the content. They browse it with enough |
| | focus to grasp its meaning. |
| Boredom | Users who are bored have likely reached their maximum |
| | attention span, causing fatigue that leads to disengagement. |
| | As a result, they may become jaded with the content. |
| Scurry | Scurrying users are preoccupied and completely disconnected |
| | from the content. As they frantically browse, they exhibit |
| | a sense of urgency and rush that corresponds to a very |
| | low level of focus. |

The terminology used to label these emotions is not intended to be exhaustive or uniquely defined. Terms such as Awe, Interest, Boredom, and Scurry are descriptive words whose selection was informed by the observable emotional expressions commonly encountered during web browsing activities. The selection process also accounted for the evolving understanding of emotional states in the context of browsing a web page, incorporating insights from user feedback and empirical observations.

As illustrated in FIG. 1A, user 102 can interact with a website shown on client device 104. The user 102 may perform a gesture 106 on the client device 104 using their finger or fingers. For example, the user 102 may perform gesture 106 by dragging his finger on the touch screen display along a particular path, such as to view a different part of the screen, tap on a GUI element, or resize the screen. The client device 104 may capture and record this gesture 106 as gesture data 108.

The gesture data 108 may include a continuous set of pressure points on the touch screen display over a period of time. For example, the gesture data 108 can include contact points along the touch screen display of client device 104 at specific times. The contact points can additionally include a pressure amount that indicates the pressure at which the user 102 pressed his or her finger or fingers at that point on the touch screen. The client device 104 can packetize the gesture data 108 and transmit the packetized gesture data 108 over the network 109 to the detection system 103.

Upon receipt of the gesture data 108 from client device 104, the detection system 103 can provide the gesture data 108 to the calibration and normalization module 110. The calibration and normalization module 110 can perform operations that calibrate portions of the gesture data 108 to reflect one or more characteristics of the user and the user's operation of the client device 104. For example, the client device 104 may capture calibration data indicative of a maximum pressure applied to the touchscreen of the client device 104 during a corresponding calibration period, and may transmit the captured calibration data to the detection system 103, which may associate the calibration data with the user 102 and the client device 104, and store the calibration data in the user metrics database 120. Other functions of the calibration and normalization module 110 can be found in U.S. patent application Ser. No. 15/669,316.

The calibrated and normalized features are provided to the feature extraction module 112. The feature extraction module 112 can process portions of the calibrated and normalized movement data to derive features that characterize the time-evolving movement of one or more portions of the user 102′s body. For example, the feature extraction module 112 may access portions of the normalized positional data and calibrated applied-force data to identifying the normalized, two-dimensional contact positions and calibrated applied-pressure values at each of the discrete detection times. The feature extraction module 112 may, in some instances, compute “micro-differences” in two dimensional positions and applied pressure between each of the discrete detection times, and based on the computed micro-differences, derive values of one or more features that characterize the time-evolving movement of the user's finger during the current collection period. Other functions of the feature extraction module 112 can be found in U.S. patent application Ser. No. 15/669,316.

The feature extraction module 112 can generate time-varying feature data 114. The generated feature data 114 includes data that identifies the derived feature values that characterize the movement of the user's finger at discrete detection times during the current collection, and the detection system 103 can provide the generated feature data 114 as input to a trained AI/ML emotion model 116. The trained AI/ML emotion model 116 can determine, from the generated feature data 114, one or more emotions represented by the free-form movement of the user's finger or fingers, e.g., gesture 106, on the touchscreen of the client device 104. In some examples, the process by which the trained AI/ML emotion model 116 determines one or more emotions using the generated feature data 114 can be found in U.S. patent application Ser. No.15/669,316.

The trained AI/ML emotion model 116 can generate a set of emotions and a likelihood for each emotion that represents the free-form movement of the gesture 106. For example, the set of emotions can include awe, interest, boredom, scurry, angry, love, desire, and others. Other emotions are also possible.

In some implementations, the trained AI/ML emotional model 116 can output a vector of emotions 118. The vector of emotions 118 includes a likelihood that the gesture data 108 represents the corresponding emotion. The detection system 103 can select the emotion whose likelihood satisfies a threshold value. For instance, if the threshold value is set to 90%, the detection system 103 can select the emotion of awe, whose likelihood is 92%. The selected emotion 119, e.g., awe with a 92% likelihood, is provided as input to the trained AI/ML engagement level model 122. For example, the trained AI/ML emotion model 116 outputs a vector of emotions and their corresponding likelihoods—boredom and 9%; interest and 1%; anger and 83%; scurry and 24%; awe and 2%; love and 40%; and desire and 47%. The detection system 103 can select emotion 119 of anger and 83%, as anger's likelihood satisfies the threshold value. In response, the detection system 103 can provide the selected emotion 119 as input to the trained AI/ML engagement level model 122. It is to be noted that the percentage values described in this disclosure are for illustrative exemplary purposes only. Other suitable values and ranges are possible in different implementations.

In some implementations, the detection system 103 can process the selection emotion 119 and the selected data 123 to produce a user engagement output 124. The data 123 retrieved from the user metrics database 120 can include, for example, data representative of the list of features. This list of features, such as those described in Table 3, represent metrics calculated from user 102's interaction with the website on client device 104. This list of features includes, for example, the visit count, the first impression metric, a user operating system ID, an engagement count, a time, and a country, to name some examples. The trained AI/ML engagement level model 122 can process (i) the selected emotion 119 and its likelihood and (ii) the data 123 retrieved from the user metrics database 120 calculated for the user 104's session.

In response, the trained AI/ML engagement level model 122 can process the inputs and generate an output 124. The output 124 can include, for example, an engagement value that indicates a user's level of engagement with the website displayed on the client device 104. In some cases, the detection system 103 can provide the output 124 to a developer of the site, to a third-party company, and/or to the client device 104. The output 124 can be provided as reporting information 126, which can include information showing how the detection system 103 arrived at its output 124. This information can include, for example, data identifying the time-varying feature data 114, the vector of emotions 118, and the data 123 selected from the user metrics database 120.

For instance, based on the emotions expressed by users as described in Table 2 above when they land on a website, the trained AI/ML engagement level model 122 classifies the emotion into a particular level from a range of levels of an initial impression. This further described in FIG. 1B, which illustrates an example of processes for predicting a user's engagement with a website. For example, the trained AI/ML engagement level model 122 first classifies the selected emotion 119 into a level. The range of levels can include values from 0 to 5, for example. Each level in the range can be described as follows:
0: A user who leaves the website within 250 ms of loading.
1: Initially expressing indifference.
2: Expressing an initial emotion of Boredom or Scurry.
3: Neutral or expressing no emotion while upon landing.
4: An initial act of clicking a button available on the webpage.
5: Initially Expressing Awe or Interest Emotions.

As illustrated in FIG. 1B, the trained AI/ML engagement level model 122 classifies the selection emotion 119 of “awe” into a level 5 classification. This classification 121 indicates an expression of aw or interest emotions from the user's gesture. The trained AI/ML engagement level model 122 provides the classification 121 as input to the engagement model 127 along with the data 123 retrieved from the user metrics database 120. As a result, the engagement model 127 outputs an engagement level value 124 of 10 out of 10. Although the value of 10 is shown for illustrative purposes, other values and number ranges are also possible. The engagement level value 124 shown in FIG. 1B indicates that the user 102 is fully engaged with the website on the client device 104.

In some implementations, to train the AI/ML engagement level model 122, the detection system 103 can collect data for an extended period of time. For example, the detection system 103 can collect data from various website interactions over a previous time period, such as collecting data over 53 weeks on an e-commerce platform. Table 3 is a sample showcase of the dataset collected and further processed for model training.

TABLE 3
Dataset Structure and Example Sample

| Device | OS | Visit | First | Session | User | Page | Engagement | | |
|---|---|---|---|---|---|---|---|---|---|
| Type | Type | Count | Impression | ID | ID | ID | Count | Time | Country |
| phone | android | 1 | 4 | s28742 | u2x | p1 | 8 | 2023 Oct. 17 | FR |
| | | | | | | | | 9:51:39 | |
| phone | iOS | 4 | 2 | s00924 | u4p | p5 | 4 | 2023 Nov. 27 | CA |
| | | | | | | | | 7:21:09 | |
| phone | android | 3 | 2 | s44881 | 9w4 | p2 | 3 | 2023 Jul. 7 | CA |
| | | | | | | | | 15:18:56 | |
| phone | iOS | 2 | 0 | s99021 | u4d | p8 | 0 | 2023 Dec. 5 | CA |
| | | | | | | | | 16:37:41 | |

In Table 3, an instance is created for every session logged on the website for each user, with the corresponding columns generated for each session:
Device-Type—Indication of whether the user accessed the website via a phone or desktop device.
OS-Type—Abbreviation for Operating System, specifying the system used by the device.
Visit Count—The total number of visits made by a user.
First Impression—A rating scale from 0 to 5 indicates the initial user experience.
Visitor ID—Unique identifiers assigned for each visitor.
Session ID—Unique session identifiers for each session.
Page ID—Unique web page identifier on the website.
Engagement Count—The total number of clicks made by the user.
Time—The local time when a user enters the website.
Country—Geographic location details of the user.

For example, the data that was collected encompasses 3,797 users tracked over a span of 53 weeks across 29 countries. In the data preprocessing phase, the detection system 103 collected data from users in Canada, accounting for 66% of the total traffic, followed by the United States with 18%. There was lower traffic from France and Romania, each contributing 7%, and Belgium had the least traffic at 2%. The data statistics guarantee the inclusion of a diverse range of users, ensuring a comprehensive comprehension of varied user experiences and behaviors across different geographical regions. This approach enhances the generalizability of the research findings, making them more relevant and applicable to a broad sample. Moreover, it bolsters the robustness of our conclusions in the context of global e-commerce behaviors.

The data in Table 4 presents First Impression scores and the percentage of users per the top 3 countries Canada, USA and France, categorized into five levels (0 to 5). The First Impression metric reflects the initial perception or impression a user forms upon landing on a website. This metric captures the emotional reaction to the first element a user encounters or experiences upon arrival on the website of the client device 104. The design and implementation of this metric are grounded in extensive research highlighting the pivotal role of first impressions in shaping user experiences on websites. Studies within the fields of web design and human-computer interaction have consistently shown that users form quick judgments regarding a website's credibility, usability, and aesthetic appeal within the initial few seconds of a visit. These early assessments can influence user engagement, satisfaction, and retention rates, underscoring the importance of capturing and understanding first impressions in the context of user interactions with web platforms.

TABLE 4
Distribution of First Impressions
Scores Across the Top 3 Countries

| Country | 0 | 1 | 2 | 3 | 4 | 5 |
|---|---|---|---|---|---|---|
| Canada | 21.55% | 9.63% | 4.87% | 15.76% | 39.89% | 8.31% |
| United States | 37.50% | 9.38% | 0.00% | 12.50% | 40.63% | 0.00% |
| France | 11.11% | 11.1% | 0.00% | 44.44% | 33.33% | 0.00% |

In Canada, for instance, a notable proportion of users (39.89%) exhibit a high initial impression score of 4, indicating a positive response to the website upon their first interaction, while a smaller percentage falls into lower impression categories. Conversely, in France, a substantial portion of users (44.44%) falls within the highest impression category, suggesting a generally positive initial response among French users. The United States displays a more varied distribution, with significant representation across multiple impression levels. Moreover, the standard deviation of initial impressions for each country provides insight into the variability of user responses within these populations. Canada demonstrates relatively low variability (standard deviation of 0.125), while France and the United States exhibit slightly higher variability (0.182 and 0.181, respectively). These findings suggest potential differences in user perception and engagement levels across countries, highlighting the importance of considering regional factors in website design and optimization strategies.

In ensuring ethical compliance and transparency in the data collection process, the detection system 103 adheres to full consent protocols and respects the legal frameworks governing data privacy and protection, including the general data protection regulation (GDPR). Throughout the data collection and beyond, the detection system 103 explicitly informs each user about the data collection through cookies with a clearly worded pop-up notification upon their first visit. This notification includes, for example, the nature of the data being collected and its purpose to enhance the user's experience. The notification provides an option for a user to willfully withdraw from the study at any point without affecting their ability to use the website. For example, users who do not consent to cookie usage can still browse the e-commerce website untracked, ensuring their browsing experience remained wholly unaffected by data collection procedures.

In some implementations, the detection system 103 ensures the collected data is anonymized so that users are not individually identifiable. To do this, the detection system 103 does not collect information related IP information and randomly assigns generated Visitor IDs and Session IDs to each user and each session. This approach ensures that the collection aligns with ethical research practices and builds trust with users, reassuring them that their personal information is not at risk of leaking.

In some implementations, the detection system 103 can utilize a Pearson's coefficient along with other evaluation metrics. For example, in some cases,, the Pearson correlation coefficient yielded a value of 0.612, the Spearman correlation coefficient resulted in 0.691, and the Kendall tau correlation coefficient was calculated to be 0.675. These metrics provided insight into the strength and direction of the relationships under examination, contributing to a comprehensive understanding of the data's interdependencies.

In some implementations, the detection system 103 collects data from various users that browse an e-commerce website for a period of time in order to build the training dataset for training the AI/ML engagement level model 122. The collection of data included, for example, collecting the “first impression” of 3,797 users, for example, when they land on the website pages. Table 5 below shows the sample refined dataset from the initial dataset (in Table 3).

TABLE 5
Refined Dataset Sample.

| User ID | First Impression | Engagement Count |
|---|---|---|
| sd7 | 5 | 10 |
| 9o2 | 2 | 3 |
| dd0 | 0 | 0 |

In some implementations, the website may be visited by the same user multiple times, with each visit being assigned a unique session ID to indicate a new browsing session. Consequently, the detection system 103 ensures that the training data set includes capturing of the user's initial impression only when they first visit a specific Page URL. If a user revisits the same Page URL after a considerable period since their previous visit, the detection system 103 generates a new session ID but does not record the initial impression into the training data. The explicit goal of building the training data set is for the detection system 103 to examine and forecast user engagement on any webpage of the e-commerce site, focusing solely on the first impression recorded during the initial visit.

During the detection system 103's testing and deployment phase, the detection system 103 utilized data from 378 unique users, while the training dataset comprised 3,419 users. In a preliminary analysis, a 70-30 division training-testing split was used to observe performance metrics across the splits. R-squared and MAE were example performance metrics used across these splits. Accordingly, given the dataset size of 3,797 visitors and computational constraints, a 10% testing set was deemed practical for the detection system 103, allowing ample data for training to capture intricate emotional patterns while still facilitating robust evaluation. Additionally, the detection system 103 implemented k-fold cross-validation (k=10) to enhance robustness, mitigate overfitting, and ensure a reliable performance estimate.

We chose to present MAE because it provides a clear and interpretable measure of the average magnitude of errors in our predictions, without considering their direction. E-commerce websites often have many visitors who do not engage with the content, resulting in a target column (“Engagement”) with a considerable number of zeroes. Given the nature of our target variable, which includes many zeroes, MAE is particularly useful as it is less sensitive to the distribution of the errors compared to other metrics like R-squared.

As a result, the detection system 103 can test the dependency of the first impression score from each user on the website to predict their level of engagement using the trained AI/ML engagement level model 122. Engagements can be defined as the users exploring and browsing something on the website by clicking (or interacting) with the content. The pre-processed data is split into 90% for training and 10% for validation. The detection system 103 can incorporate a selection of diverse algorithms tailored to the detailed nature of the dataset. The Huber Regressor is chosen for its robustness to outliers, aiming to strike a balance between Mean Squared Error (MSE) and Mean Absolute Error (MAE) and mitigate the impact of extreme values on the model.

In some implementations, the detection system 103 includes a Light Gradient Boosting Machine (LightGBM) for the trained AI/ML engagement level model 122 to use. The LightGBM is included for its efficiency in handling large datasets and complex relationships through gradient boosting. In some cases, the detection system 103 includes an Extra Trees Regressor (ET) and Decision Tree Regressor (DT) for the trained AI/ML engagement level model 122 due to their additional flexibility and interpretability, allowing us to explore different facets of the data's structure. In some cases, the detection system 103 includes an XGBoost, known for its scalability and predictive power, is leveraged for the trained AI/ML engagement level model 122 to enhance predictive accuracy.

In some cases, the detection system 103 includes a Random Forest Regressor (RF) as the trained AI/ML engagement level model 122 due to its strength of ensemble learning and decision trees, offering robustness and versatility in capturing underlying patterns. Similarly, the detection system 103 can include a Linear Regression (LR) due to its baseline for simplicity and interpretability, offering insights into linear relationships within the data. In some cases, the detection system 103 can include AdaBoost as the trained AI/ML engagement level model 122 because, through adaptive boosting, it aims to improve the accuracy of weaker models sequentially, providing an ensemble approach for enhanced predictive performance.

In some implementations, the detection system can choose chose tree-based algorithms for their handling of complex, non-linear relationships well and are robust to the characteristics of the collected data. The collected dataset includes numerical and string data types, hence models capable of handling complex data objects are chosen such as tree-based models. These models are capable of handling datasets with features of arbitrary data types while retaining each feature characteristic. After experimenting with a wide range of algorithms, the detection system 103 can utilize tree-based models, which were found to deliver better results. The selected algorithms include:
Huber Regressor: Included for its robustness to outliers, serving as a comparison to tree-based methods.
LightGBM and XGBoost: Powerful gradient boosting methods known for their efficiency and high performance on structured data.
Extra Trees and Random Forest Regressors: Ensemble methods that provide high accuracy and reduce overfitting.
Decision Tree Regressor: A simple and interpretable model, providing a baseline for comparison within tree-based methods.
Linear Regression: Included as a baseline linear model.
AdaBoost: An ensemble method that enhances the performance of weak learners, demonstrating the benefits of boosting.

In some implementations, the MAE was chosen for its ability to provide a clear and interpretable measure of the average magnitude of errors in the predictions of user engagement, without considering their direction. Websites, such as e-commerce websites, often have many visitors who do not engage with the content, resulting in a target column (“Engagement”) with a considerable number of zeroes. Given the nature of the target variable, which includes many zeroes, MAE is particularly useful as it is less sensitive to the distribution of the errors compared to other metrics like R-squared.

The mathematical form of the Huber Regressor model is as follows in equation 1:

$${min}_{w} \frac{1}{2} {‖ w ‖}^{2} + {\sum }_{i = 1}^{n} {L}_{δ} ( {y}_{i} - {w}^{T} {x}_{i} ) \qquad ( 1 )$$

Where:
w is the vector w of model parameters.
//w// denotes the L2 norm of the weight vector w, which is used for regularization to prevent overfitting.
yᵢ is the true value for the i-th observation.
xᵢ is the feature vector for the i-th observation.
w^{T}xᵢ is the predicted value for the i-th observation.
L_{δ} is the Huber loss function, which is a combination of the squared error loss for small residuals and the absolute error loss for large residuals, controlled by the parameter δ.

The Huber Regressor model was trained using the independent variables-First Impression (IV) extracted from user interactions with the e-commerce website, while the dependent variable (DV) was the level of user engagement, measured using Mean Absolute Error (MAE) as the evaluation metric.

In some implementations, a goal of the detection system 103 is to predict the level of engagement from the first impression score of the users when they land on a webpage for the first time. Table 6 presents a comparison of Mean Absolute Errors (MAE) and their corresponding Mean Squared Errors (MSE). The lower the score of MAE, the better fit the model. This can be compared with standard machine learning models to predict the level of engagement.

TABLE 6
Top Algorithms Ranked by MAE Scores (Lowest to Highest).

| Algorithm | MAE | MSE |
|---|---|---|
| 1 Huber Regressor | 1.6010 | 3.2120 |
| 2 Light GGM | 1.9311 | 4.2107 |
| 3 Extra Trees Regressor | 1.9315 | 4.2370 |
| 4 Decision Trees Regressor | 1.9315 | 4.3540 |
| 5 XGBoost | 1.9315 | 4.2810 |
| 6 Random Forest Regressor | 1.9401 | 4.3675 |
| 7 Linear Regression | 1.9484 | 4.3998 |
| 8 AdaBoost | 2.0310 | 4.8125 |

Many of these models offer varying degrees of interpretability. The Decision Tree Regressor stands out for its simplicity and easy interpretation, as it directly maps decision rules. Additionally, Linear Regression provides straightforward interpretation by quantifying the relationship between input features and the target variable. While ensemble methods like Random Forest and Extra Trees offer high predictive accuracy, their interpretability may be somewhat limited due to their complex nature. However, using techniques such as feature importance helps to understand which models work for the desired function of predicting user engagement.

To comprehensively evaluate the performance of these regression algorithms, the detection system 103 can employ a suite of standard evaluation metrics. Mean Absolute Error (MAE) and Mean Squared Error (MSE) are chosen to quantify the magnitude and distribution of errors, respectively. R-squared (R²) elucidates the proportion of variance in the dependent variable captured by the model. By adopting this diverse set of regression algorithms and evaluation metrics, the detection system 103 can uncover the most effective modeling approach for the specific regression task, considering both predictive accuracy and the interpretability of the underlying relationships within the data.

The detection system 103 evaluates the performance of various regression algorithms on the dataset, and the Mean Absolute Error (MAE) metric was used to assess their predictive accuracy. MAE was chosen as the deciding metric because no limit exists to the count of engagement and it is a continuous value. MAE quantifies the average absolute difference between the predicted values and the actual values in the dataset. MAE involves calculating the absolute differences for each data point, summing them up, and then dividing by the total number of data points. MAE provides a straightforward and interpretable measure of the average magnitude of errors, making it a useful tool for evaluating the overall performance of a regression model in terms of prediction accuracy. Adaboost has the highest MAE which depicts low accuracy levels.

Among the eight algorithms considered, the Huber Regressor demonstrated superior performance with the lowest MAE of 1.60 units. This suggests that, on average, the predictions made by the Huber Regressor were closest to the actual values, indicating a high level of accuracy in capturing the details of the underlying data. Following closely behind were LightGBM, Extra Trees Regressor, Decision Tree Regressor, and XGBoost, all with comparable MAE scores of around 1.93 units. Random Forest Regressor exhibited a slightly higher MAE at 1.94 units, while Linear Regression and AdaBoost showed comparatively higher errors at 1.9484 and 2.03 units, respectively. The results indicate that the Huber Regressor outperforms other algorithms in terms of minimizing prediction errors, making it a favorable choice for accurate predictions in the specific context of this dataset. As a result, the detection system 103 chose the Huber Regressor model for deployment.

Huber Regressor has the lowest MAE score amongst 8 algorithms with 1.6 units as error rate. A lower MAE indicates that the model's predictions are, on average, close to the actual values, highlighting its accuracy in capturing the distinctions of the e-commerce data. In the context of e-commerce platforms or websites, where precision in predicting outcomes is important for decision-making, the Huber Regressor's low MAE of 1.6 units signifies its effectiveness in providing reliable and accurate predictions, making it a favorable algorithm for this specific application.

Gesture-based emotion analysis was employed to capture users' initial impressions, encompassing gestures like clicks, scrolls, swipes, and taps on mobile touch surfaces. The detection system 103's first impression metric captures the initial emotional response to a product or service and this initial impression can have a significant impact on their overall impression of the site. The result of this research demonstrates a strong correlation between five levels of users' first impression to the subsequent engagement during their visit to a website. The validated regression model demonstrated commendable performance, as indicated by a Mean Absolute Error (MAE) score of 1.60. This relatively low MAE suggests that the model's predictions closely align with the actual values, reflecting a high level of accuracy. The implications for diverse users highlight the importance of aligning website content and aesthetic design with users' emotions to drive engagement.

In some implementations, the detection system 103 can train and deploy a machine learning model to predict a user engagement level from the first-impression scores, determined from gesture emotion recognition.

The pre-processed data was trained and validated with different regression algorithms and the most accurate and precise algorithm was selected. With just one input, e.g., first-impression score, the Huber regressor model gave a powerful output of 1.6 units error as MAE. This concludes that first-impression scores have a high chance of predicting the user engagement count. Hence, this study accurately predicts user engagement from the first impression expressed by the user based on the web page's physical environment such as visuals, colors, amount of text, and the browsing session time of the user.

The detection system 103 can be used in any commercial platform to get the user's first impression analysis even before the platform becomes completely live for the public to get in-depth insights about the content, layout, UI/UX, images, text, and many page properties. This analysis can aid in better understanding the platform's performance and can be revised to match user's preferences and expectations.

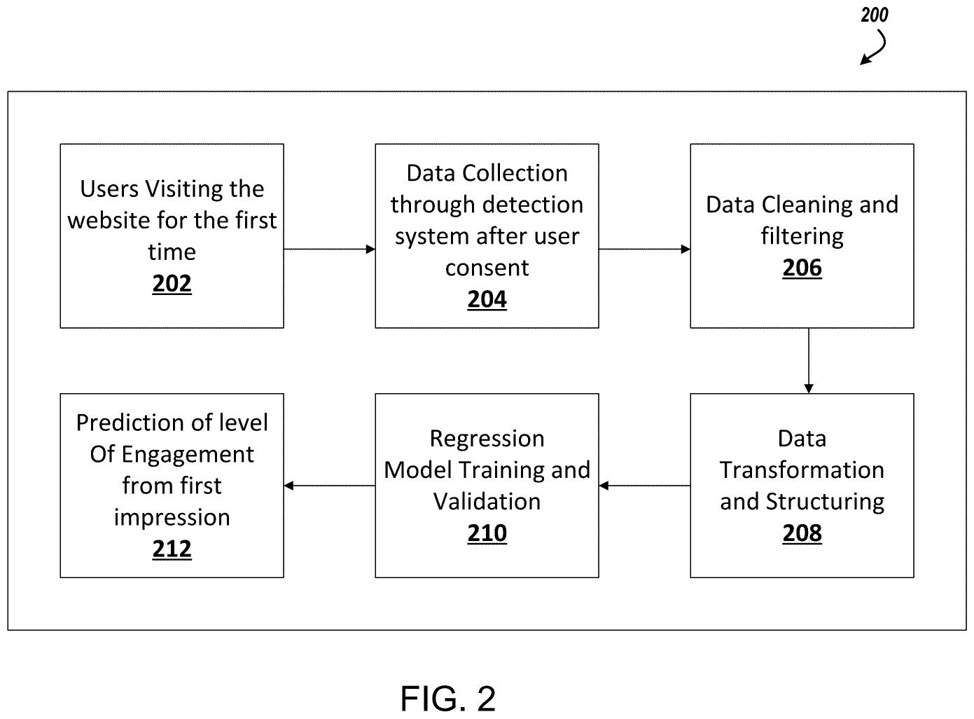

FIG. 2 is a block diagram that illustrates an example integrated data flow 200 for predicting user engagement. At 202, the detection system 103 detects users visiting the website for the first time. At 204, the detection system 103 collects data from the user interaction with the website or interactive site. At 206, the detection system 103 normalizes, calibrates, and filters the collected data. At 208, the detection system 103 transforms and structures the data into tables. At 210, the detection system 103 performs model training and validation for training the AI/ML engagement level model. At 212, the detection system 103 can deploy the trained AI/ML engagement level model to predict a level of engagement of a user from the user's first impression of the website.

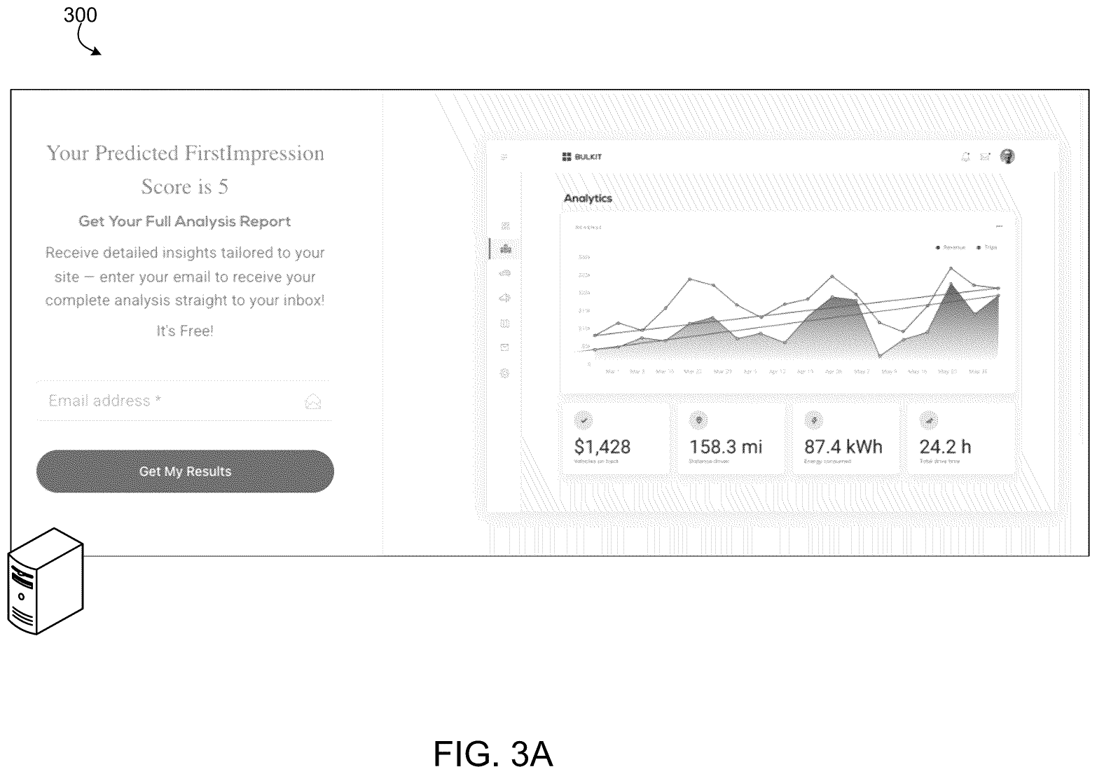

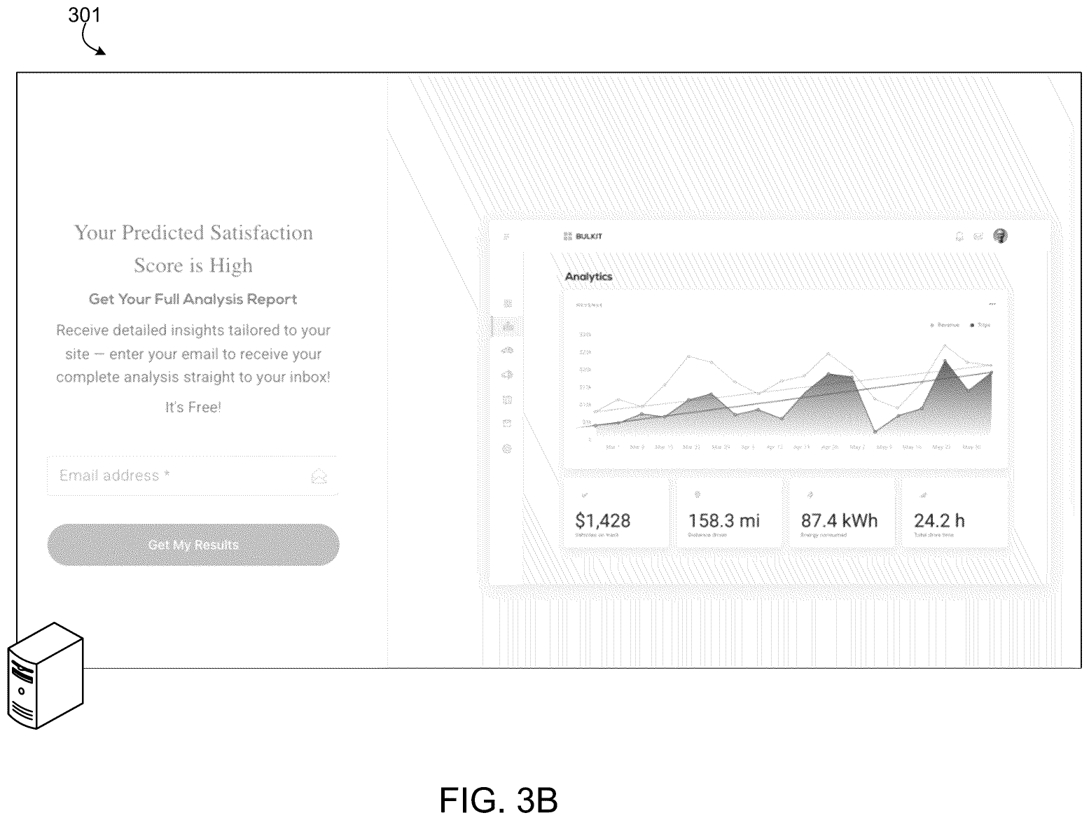

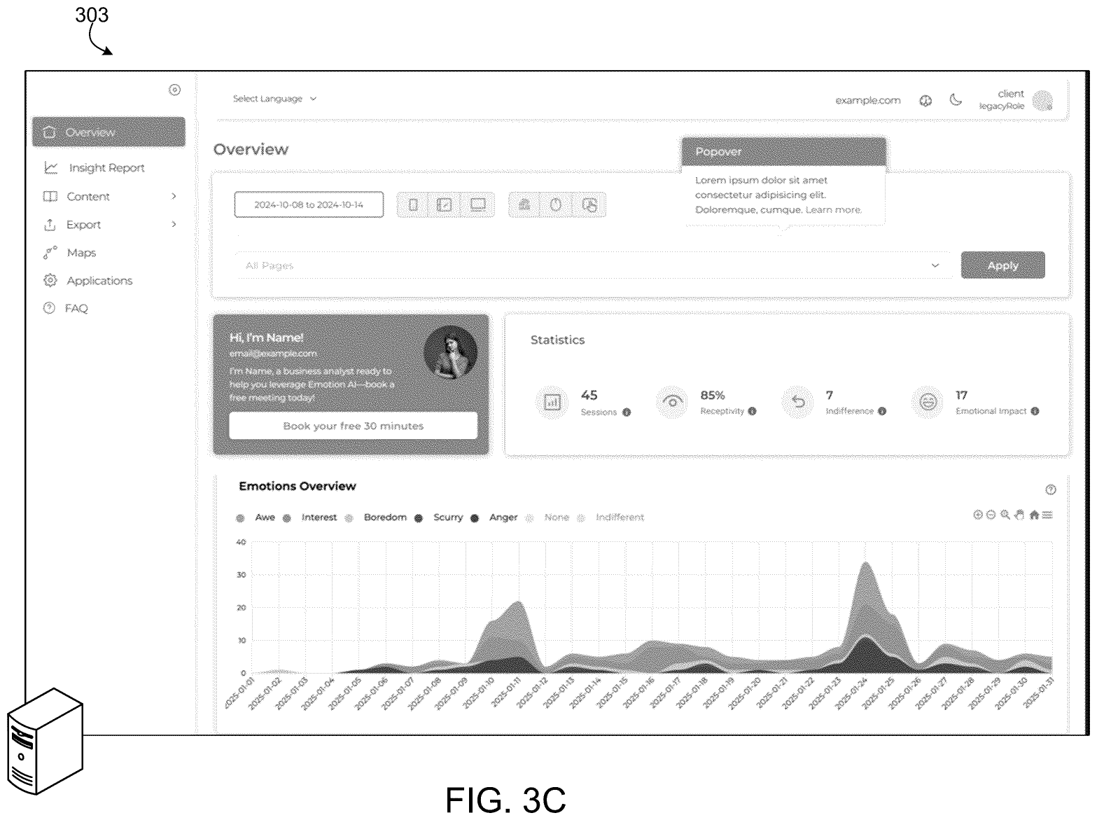

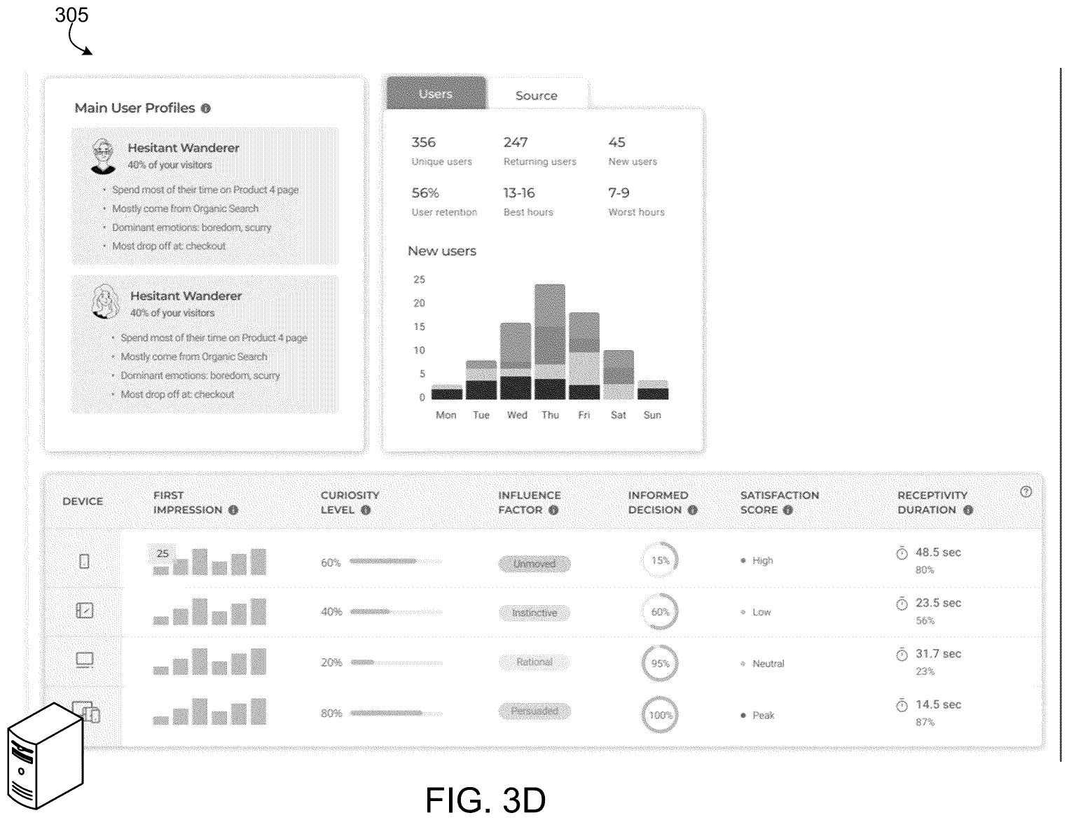

FIG. 3A is an example graphical user interface 300 that illustrates a user's engagement with a website over time. The graphical user interface 300 illustrates the user's engagement with the website and reflects a first impression score of 5. The system also enables providing detailed insights tailored to your site to the user's email.

FIG. 3B is another example graphical user interface 301 that illustrates a user's engagement with a website over time. The graphical user interface 301 illustrates the predicted satisfaction score with the website to be high.

FIG. 3C is another example graphical user interface 303 that illustrates a user's engagement with a website over time. The graphical user interface 303 illustrates a dashboard with various emotions detected for a user when visiting different websites over time. The statistics show different sessions, receptivity scores, indifference, emotional impacts, and engagement with different websites that can be further explored by the user interacting with the graphical user interface 303 or the dashboard.

FIG. 3D is another example graphical user interface 305 that illustrates a user's engagement with a website over time. The graphical user interface 305 illustrates a dashboard with various emotions detected for a user when visiting different websites over time. The statistics shown on the dashboard illustrate, for example, first impression scores for a user, curiosity levels, influence factor, informed decision, satisfaction score, and receptivity duration. The graphical user interface 305 also describes times during the week when new users visit the website.

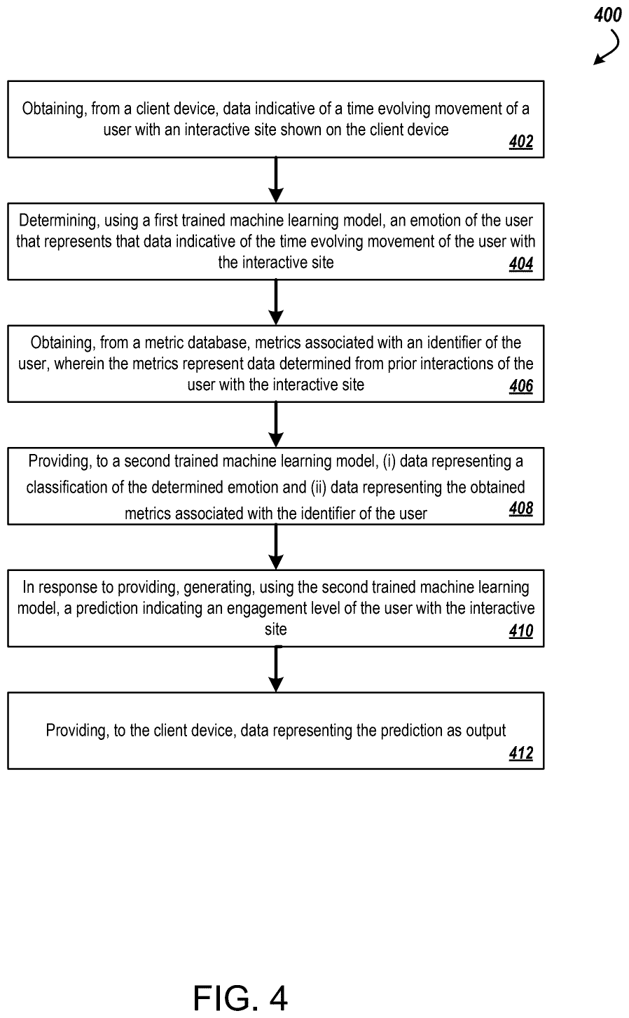

FIG. 4 is a flow diagram that illustrates a process 400 for predicting a user's engagement with a website according to gesture based emotion recognition. A detection system, such as detection system 103, can perform the process 400.

During 402, the detection system obtains, from a client device, data indicative of a time evolving movement of interactions of a user with a website shown on the client device. Obtaining the data includes the detection system determining normalized and calibrated values for the data indicative of the time evolving movement. The system can generate feature values that characterize the normalized and calibrated values. For example, the generated feature values include at least one of speed, acceleration, contract duration, a change in contact pressure, or a finger size. Moreover, the detection system can obtain the data indicative of the time evolving movement of a portion of a body of the user with the website shown the client device, and the portion of the body includes a finger and the client device includes a touchscreen display. Here, the data indicative of the time evolving movement includes a plurality of contacts established sequentially between a finger of the user and a surface of a touchscreen display of the client device at corresponding contact times, wherein the plurality of contacts includes contact positions, contact pressures, and the contact times associated with each of the contacts.

In some cases, obtaining the data indicative of the time evolving movement of the user includes the detection system obtaining, from the client device, data indicating the time evolving movement of the user that includes clicks, scrolls, swipes, and taps using an input mechanism of an electronic device used to visit the website.

During 404, the detection system determines, using a first trained machine learning model and based on the data indicative of the time evolving movement of the user interacting with the website, a metric associated with an emotion of the user corresponding to the user's interaction with the website. For example, the detection system obtains, from the first trained machine learning model, a vector that includes a plurality of emotions and a likelihood for each emotion of the plurality of emotions. The likelihood for each emotion represents how likely a corresponding emotion represents that data indicative of the time evolving movement of the user. The detection system can compare the likelihood for each emotion of the plurality of emotions to a threshold value. In response to comparing the likelihood for each emotion of the plurality of emotions to the threshold value, the detection system can select, as the metric associated with the emotion, the emotion of the plurality of emotions whose likelihood satisfies the threshold value, wherein the metric comprises a label for the emotion and a corresponding likelihood for the emotion.

During 406, the detection system obtains, from a metric database, one or more metrics associated with an identifier of the user, wherein the metrics represent data determined from prior interactions of the user with the website. In particular, the detection system can determine the identifier of the user that performed a time evolving movement on the client device with the website. The identifier can include, for example, an identifier that does not personally reveal information about the user, and may include the visitor ID. The detection system can select, from the metrics database, the one or more metrics associated with the identifier of the user, wherein the one or more metrics comprise at least one of a session ID, a visitor ID, a visit count, a return, a session duration, a first impression, a number of emotions expressed, a duration of emotions expressed, entry and exit local times, or engagement information.

During 408, the detection system provides, to a second trained machine learning model, (i) the metric associated with the emotion of the user and (ii) data representing the obtained metrics associated with the identifier of the user. The second trained machine learning model includes a Light Gradient Boosting Machine. Moreover, the detection system generates a classification of the emotion of the user according to a table of classification values. The table of classification values includes a number for each determined emotion, the number representing an expression of the user for performing the time evolving movement. The detection system can provide, to the second trained machine learning model, (i) the number corresponding to determined emotion and (ii) the data representing the obtained metrics associated with the identifier of the user.

For example, the detection system provides, to the Light Gradient Boosting Machine, (i) the data representing classification of the determined emotion and (ii) the data representing the obtained metrics associated with the identifier of the user, and the Light Gradient Boosting Machine is configured to process numerical and categorical features to predict the user's engagement with the website or the interactive site.

During 410, in response to the providing, the detection system generates, using the second trained machine learning model, a prediction indicating an engagement level of the user with the website. Generating the prediction includes the detection system generating, using the second trained machine learning model, a score that classifies the engagement level of the user with the website during a particular session. In some cases, generating the predicting indicating the engagement level of the user includes the detection system generating, using the second trained machine learning model, at least one of an initial emotional response of the user to the website or an overall impression of the website.

During 412, the detection system provides, to the client device, data representing the prediction as output. In some cases, the one or more devices can be separate devices from the client device that provided the data indicative of the time evolving movement of the user. The one or more devices can be devices associated with a developer, a third party, or another party. In some cases, the one or more devices can include the client device that provided the data indicative of the time evolving movement of the user.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification), or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining, from a client device, data indicative of a time evolving movement of interactions of a user with a website shown on the client device;
determining, using a first trained machine learning model and based on the data indicative of the time evolving movement of the user interacting with the website, a metric associated with an emotion of the user corresponding to the user's interaction with the website;
obtaining, from a metric database, one or more metrics associated with an identifier of the user, wherein the metrics represent data determined from prior interactions of the user with the website;
providing, to a second trained machine learning model, (i) the metric associated with the emotion of the user and (ii) data representing the obtained metrics associated with the identifier of the user;
in response to the providing, generating, using the second trained machine learning model, a prediction indicating an engagement level of the user with the website; and
providing, to one or more devices, data representing the prediction as output.

2. The computer-implemented method of claim 1, wherein obtaining the data indicative of the time evolving movement of the user with the website shown on the client device further comprises:
determining normalized and calibrated values for the data indicative of the time evolving movement; and
generating feature values that characterize the normalized values, wherein the generated feature values comprise at least one of speed, acceleration, contact duration, a change in contact pressure, or a finger size.

3. The computer-implemented method of claim 1, wherein obtaining the data indicative of the time evolving movement of the user with the website shown on the client device further comprises:
obtaining, from the client device, the data indicative of the time evolving movement of a portion of a body of the user with the website shown on the client device,
wherein the portion of the body comprises a finger and the client device comprises a touchscreen display.

4. The computer-implemented method of claim 1, wherein determining the metric associated with an emotion of the user corresponding to the user's interaction with the website comprises:
obtaining, from the first trained machine learning model, a vector that comprises a plurality of emotions and a likelihood for each emotion of the plurality of emotions, wherein a likelihood represents how likely a corresponding emotion represents the data indicative of the time evolving movement of the user;
comparing the likelihood for each emotion of the plurality of emotions to a threshold value; and
in response to comparing the likelihood for each emotion of the plurality of emotions to the threshold value, selecting, as the metric associated with the emotion, the emotion of the plurality of emotions whose likelihood satisfies the threshold value, wherein the metric comprises a label for the emotion and a corresponding likelihood for the emotion.

5. The computer-implemented method of claim 1, wherein obtaining the one or more metrics associated with the identifier of the user further comprises:
determining the identifier of the user that performed a time evolving movement on the client device with the website; and
selecting, from the metric database, the one or more metrics associated with the identifier of the user, wherein the one or more metrics comprise at least one of a session ID, a visitor ID, a visit count, a return, a session duration, a first impression, a number of emotions expressed, a duration of emotions expressed, entry and exit local times, or engagement information.

6. The computer-implemented method of claim 1, wherein the second trained machine learning model comprises a Light Gradient Boosting Machine.

7. The computer-implemented method of claim 1, wherein providing, to a second trained machine learning model, (i) the metric associated with the emotion of the user and (ii) data representing the obtained metrics associated with the identifier of the user comprises:
generating a classification of the emotion of the user according to a table of classification values, wherein the table of classification values comprises a number for each emotion, the number representing an expression of the user for performing the time evolving movement; and
providing, to the second trained machine learning model, (i) the number corresponding to the emotion and (ii) the data representing the obtained metrics associated with the identifier of the user.

8. The computer-implemented method of claim 1, wherein generating, using the second trained machine learning model, the prediction indicating an engagement level of the user with the website comprises generating, using the second trained machine learning model, a score that classifies the engagement level of the user with the website during a particular session.

9. The computer-implemented method of claim 1, wherein the data indicative of the time evolving movement comprises a plurality of contacts established sequentially between a finger of the user and a surface of a touchscreen display of the client device at corresponding contact times, wherein the plurality of contacts comprises contact positions, contact pressures, and the contact times associated with each of the contacts.

10. The computer-implemented method of claim 1, wherein obtaining, from a client device, data indicative of a time evolving movement of a user interacting with a website shown on the client device comprises obtaining, from the client device, data indicating the time evolving movement of the user that comprises clicks, scrolls, swipes, and taps using an input mechanism of an electronic device used to visit the website.

11. The computer-implemented method of claim 1, wherein generating, using the second trained machine learning model, a prediction indicating an engagement level of the user with the website comprises generating, using the second trained machine learning model, at least one of an initial emotional response of the user to the website or an overall impression of the website.

12. A system comprising:
one or more computers and one or more storage devices storing instructions that are operable, when executed by the one or more computers, to cause the one or more computers to perform operations comprising:
obtaining, from a client device, data indicative of a time evolving movement of interactions of a user with a website shown on the client device;
determining, using a first trained machine learning model and based on the data indicative of the time evolving movement of the user interacting with the website, a metric associated with an emotion of the user corresponding to the user's interaction with the website;
obtaining, from a metric database, one or more metrics associated with an identifier of the user, wherein the metrics represent data determined from prior interactions of the user with the website;
providing, to a second trained machine learning model, (i) the metric associated with the emotion of the user and (ii) data representing the obtained metrics associated with the identifier of the user;
in response to the providing, generating, using the second trained machine learning model, a prediction indicating an engagement level of the user with the website; and
providing, to one or more devices, data representing the prediction as output.

13. The system of claim 12, wherein obtaining the data indicative of the time evolving movement of the user with the website shown on the client device further comprises:
determining normalized and calibrated values for the data indicative of the time evolving movement; and
generating feature values that characterize the normalized values, wherein the generated feature values comprise at least one of speed, acceleration, contact duration, a change in contact pressure, or a finger size.

14. The system of claim 12, wherein obtaining the data indicative of the time evolving movement of the user with the website shown on the client device further comprises:
obtaining, from the client device, the data indicative of the time evolving movement of a portion of a body of the user with the website shown on the client device,
wherein the portion of the body comprises a finger and the client device comprises a touchscreen display.

15. The system of claim 12, wherein determining the metric associated with an emotion of the user corresponding to the user's interaction with the website comprises:
obtaining, from the first trained machine learning model, a vector that comprises a plurality of emotions and a likelihood for each emotion of the plurality of emotions, wherein a likelihood represents how likely a corresponding emotion represents the data indicative of the time evolving movement of the user;
comparing the likelihood for each emotion of the plurality of emotions to a threshold value; and
in response to comparing the likelihood for each emotion of the plurality of emotions to the threshold value, selecting, as the metric associated with the emotion, the emotion of the plurality of emotions whose likelihood satisfies the threshold value, wherein the metric comprises a label for the emotion and a corresponding likelihood for the emotion.

16. The system of claim 12, wherein obtaining the one or more metrics associated with the identifier of the user further comprises:
determining the identifier of the user that performed a time evolving movement on the client device with the website; and
selecting, from the metric database, the one or more metrics associated with the identifier of the user, wherein the one or more metrics comprise at least one of a session ID, a visitor ID, a visit count, a return, a session duration, a first impression, a number of emotions expressed, a duration of emotions expressed, entry and exit local times, or engagement information.

17. The system of claim 12, wherein the second trained machine learning model comprises a Light Gradient Boosting Machine.

18. The system of claim 12, wherein providing, to a second trained machine learning model, (i) the metric associated with the emotion of the user and (ii) data representing the obtained metrics associated with the identifier of the user comprises:
generating a classification of the emotion of the user according to a table of classification values, wherein the table of classification values comprises a number for each emotion, the number representing an expression of the user for performing the time evolving movement; and
providing, to the second trained machine learning model, (i) the number corresponding to the emotion and (ii) the data representing the obtained metrics associated with the identifier of the user.

19. The system of claim 12, wherein generating, using the second trained machine learning model, the prediction indicating an engagement level of the user with the website comprises generating, using the second trained machine learning model, a score that classifies the engagement level of the user with the website during a particular session.

20. A non-transitory computer-readable medium storing software comprising instructions executable by one or more computers which, upon such execution, cause the one or more computers to perform operations comprising:
obtaining, from a client device, data indicative of a time evolving movement of interactions of a user with a website shown on the client device;
determining, using a first trained machine learning model and based on the data indicative of the time evolving movement of the user interacting with the website, a metric associated with an emotion of the user corresponding to the user's interaction with the website;
obtaining, from a metric database, one or more metrics associated with an identifier of the user, wherein the metrics represent data determined from prior interactions of the user with the website;
providing, to a second trained machine learning model, (i) the metric associated with the emotion of the user and (ii) data representing the obtained metrics associated with the identifier of the user;
in response to the providing, generating, using the second trained machine learning model, a prediction indicating an engagement level of the user with the website; and
providing, to one or more devices, data representing the prediction as output.
